(19) United States
(12) Patent Application Publication
(10) Pub. No.: US 2005/0043473 A1
(43) Pub. Date: Feb. 24, 2005

(54) Assembly adhesive based on an aqueous polymer dispersion

(75) Inventors: Alexander Centner, Roedersheim-Gronau (DE); Dieter Flick, Boehl-Iggelheim (DE); Christina Wichmann, Waldsee (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/910,587

(22) Filed: Aug. 4, 2004

(30) Foreign Application Priority Data
Aug. 20, 2003 (DE) 10338858.3

(51) Int. Cl. C08K 3/00

(52) U.S. Cl. 524/556

(57) ABSTRACT

The present invention relates to an adhesive comprising at least one copolymer selected from the group consisting of ethylenically unsaturated monocarboxylic and dicarboxylic acids, their anhydrides, their ester derivatives, and mixtures thereof and also at least one thickener and further customary auxiliaries. The present invention also relates to the preparation of this adhesive and to its use as an assembly adhesive.

The present invention relates to an adhesive comprising at least one copolymer selected from the group consisting of ethylenically unsaturated monocarboxylic and dicarboxylic acids, their anhydrides, their ester derivatives, and mixtures thereof and also at least one thickener and further customary auxiliaries. The present invention also relates to the preparation of this adhesive and to its use as an assembly adhesive.

Assembly adhesives, also called construction adhesives, are compositions whose properties render them suitable for diverse assembly tasks, especially in the construction industry. More and more often, however, assembly adhesives are also being used to bond components in the construction, for example, of vehicles, aircraft, and boats or in the manufacture of furniture. They exhibit very high initial adhesion in combination with an ultimately effective load-bearing capacity in the bonding of wood, metal, ceramic, PVC and other plastics in both interior and exterior applications, as well as having particular abilities in respect of crack bridging, spectrum of adhesion, and flexibility.

One application of assembly adhesives is the rapid and durable fixing of articles to ceilings, walls, and floors. Assembly adhesives are frequently also employed in the laying of wood floors (e.g., woodblock flooring), for repair work, and also for fixing purposes in the laying of carpet, PVC or linoleum, both on the floor and on the walls. In general, the favorable properties of assembly adhesives allow them to be used as a sealant too. The critical task with assembly adhesives is to marry toughness and stability on the one hand with advantageous flow properties on the other. A particular desire is for the rapid and easy assembly of heavy articles without any need for additional fixing. The adhesive must be capable, moreover, of bridging unevennesses in material (crack bridging).

The maximum initial adhesion of the known assembly adhesives available at present on the market does not exceed 30 g cm⁻². Accordingly, in the fixing of relatively large, dimensionally stable articles, such as ceiling panels, for example, problems occur. Further assembly problems arise during the assembly of articles which are under tension, such as curved baseboard strips, for example. These articles require additional fixing until the adhesive has cured.

There are basically four kinds of assembly adhesive:
a) solvent-based systems
b) reactive systems
c) hotmelt adhesives
d) water-based systems.

Solvent-based adhesives are particularly unpopular when used for bonding over large areas indoors, owing to the frequent incidence of odor nuisance caused by liberated solvent vapors. The advantages associated with the use of solvent-based systems is that the solvent present can escape quickly from the adhesive, so leading relatively quickly to a high level of adhesion for assembly operations.

Reactive systems and hotmelts either require special conditions/specialty apparatus for their processing or a relatively long time in order to develop adequate adhesion properties for assembly operations.

Water-based systems have the disadvantage that they only give off the water present slowly. The curing of the adhesive is therefore a relatively slow process. The great advantage of the water-based systems is the absence of odor nuisance and/or health hazard due to solvents released. To date, however, there have been no assembly adhesives with adhesion values >30 g cm⁻².

GB 2 061 990 describes an adhesive for fixing ceramic tiles, comprising
from 2 to 50% by weight of an aqueous dispersion or solution of an organic polymer having a solids content of from 30 to 70%,
from 40 to 80% by weight of an inorganic filler,
from 0.5 to 15% by weight of an organic additive, and
from 0 to 10% by weight of auxiliaries.

In the examples, adhesives are prepared from the following components:
100 parts by weight of styrene/acrylate copolymer in the form of a dispersion with a solids content of 45%,
450 parts by weight of sand with different grain sizes,
5 parts by weight of a coalescence solvent based on an aromatic glycol ether,
1 to 2 parts by weight of cellulose ether with a viscosity of 15 000, as thickener,
2 to 1 parts of Aerosil, and
50 to 55 parts by weight of water.

Organic thickeners referred to, in addition to cellulose ethers, include polyacrylates. The purpose of this adhesive is to fix ceramic tiles to the floor. A disadvantage of the adhesive described is that its initial adhesion is still too low to fix heavy articles, such as tiles, to walls immediately after the adhesive has been spread.

WO 01/74961 discloses an assembly adhesive based on an aqueous styrene/acrylate dispersion.

Attempts in the past to carry out extreme thickening of acrylate dispersions containing high concentrations of acrylate thickeners, for the purpose of achieving a high initial adhesion (in particular by way of the viscosity), led only to adhesives of very high viscosity which were difficult to process, lacked storage stability, and showed poor wetting on the substrates to be bonded.

It is an object of the present invention to develop a storage-stable adhesive having high initial adhesion for the fixing of heavy articles, which is easy to employ. The adhesive ought to exhibit improved adhesion on low-absorbency substrates and ought to possess a relatively high level of film extension.

We have found that this object is achieved by an adhesive comprising
(A) 10-98% by weight of an aqueous polymer dispersion comprising at least one monomer selected from the group consisting of ethylenically unsaturated monocarboxylic and dicarboxylic acids, their anhydrides, their ester derivatives, and mixtures thereof,
(B) 1-10% by weight of at least one thickener,
(C) 0-90% by weight of fillers,
(D) 0-5% by weight of pigments,
(E) 0-10% by weight of auxiliaries,
(F) 0-40% by weight of plasticizers,
(G) water, and
(H) tackifiers.

The adhesive of the invention is notable for improved processing properties, good extrudability, and an extended open time.

The invention further provides a process for preparing the adhesive, provides for its use as an assembly adhesive and for its use on low-absorbency substrates.

The adhesive of the invention comprises an aqueous polymer dispersion A) composed at 10-98% by weight comprising at least one monomer selected from the group consisting of ethylenically unsaturated monocarboxylic and dicarboxylic acids, their anhydrides, their ester derivatives, and mixtures thereof (monomers a) below).

The monomers a) comprehend, among others, vinyl esters of alkanecarboxylic acids having 1 to 3 carbon atoms, esters of acrylic or methacrylic acid with alcohols having 1 to 12 carbon atoms, and also monoethylenically unsaturated dicarboxylic acids having 1 to 12 carbon atoms, their amide or ester derivatives, monoesters of the dicarboxylic acids, their anhydrides, and mixtures thereof. The acids can also be used in the form of their neutralization products, as well as their sodium or potassium salts.

The alkyl group in the acrylates can be linear, branched or cyclic and may have been substituted.

The alkyl groups having 1 to 12 carbon atoms comprehend, for example, the methyl, ethyl, isopropyl, butyl, dodecyl, cyclohexyl, 2-ethylhexyl or 2-hydroxyethyl group.

The acrylic esters may also contain reactive groups for subsequent post-crosslinking, examples being silane groups. The Si₍ₐₗₖ₎₃ group can be attached directly or via a (CH₂)ₙ radical to the vinyl group. n here can be a number from 2 to 6, preferably 1 or 2.

Besides the monomers a), the polymer may further contain from 0 to 95% by weight of monomers b).

Examples of monomers b) which can be included are vinyl esters of carboxylic acids having 1-20 carbon atoms, such as vinyl formate, vinyl acetate, vinyl propionate, vinyl laurate and vinyl esters of highly branched, saturated monocarboxylic acids having C₉-C₁₁ side chains (Versatic acids), maleic esters (in each case with from 1 to 12, preferably 2 to 8, carbon atoms in the alcohol component), ethylene, ethylenically unsaturated nitriles such as acrylonitrile and methacrylonitrile, vinyl and vinylidene halides, such as vinyl chloride and vinylidene chloride, vinyl ethers, C₂-C₈ monoolefins, nonaromatic hydrocarbons having at least 2 conjugated double bonds (butadiene, isoprene, chloroprene), C₁-C₁₀ hydroxyalkyl (meth)acrylates, N-vinyl amides, N-vinyl lactams, and amides of α,β-ethylenically unsaturated monocarboxylic acids. Particularly suitable monomers are acrylic acid, methacrylic acid, methyl (meth)acrylate, ethyl (meth)acrylate, n-butyl (meth)acrylate, isobutyl (meth)acrylate, tert-butyl (meth)acrylate, 2-ethylhexyl acrylate, hydroxyethyl acrylate, hydroxyethyl methacrylate, hydroxypropyl acrylate, and hydroxybutyl acrylate. Particular preference is given to n-butyl acrylate and methyl methacrylate.

The monomers can be used individually or in mixtures.

Use may be made of di- or polyethylenically unsaturated monomers which lead to crosslinking on polymerization, examples being the diesters of dihydric alcohols with α,β-monoethylenically unsaturated monocarboxylic acids, such as propanediol bisacrylate and the corresponding methacrylates.

In the polymerization it is also possible to use regulators. Examples of suitable regulators include compounds having a thiol group, such as tert-butyl mercaptan, mercaptoethane, and mercaptopropyltrimethoxysilane.

The aqueous polymer dispersions for use in accordance with the invention embrace embodiments whose polymer, present in disperse distribution, contains 10-98% by weight, preferably from 20 to 85% by weight, in particular from 30 to 70% by weight (the figures referring to the liquid dispersion) of ethylenically unsaturated monocarboxylic or dicarboxylic acids, their anhydrides, their ester derivatives or mixtures thereof.

The copolymers can be synthesized by customary polymerization processes as bulk polymerization, solution polymerization and, where the solubility of the monomers is poor, as emulsion, dispersion or suspension polymerization. Where the solubility of the polymer in the reaction mixture is sufficiently poor it is likewise possible to conduct the polymerization as a precipitation polymerization.

With the stated polymerization processes it is preferred to operate in the absence of oxygen, preferably in a stream of nitrogen. For all polymerization methods the customary apparatus is used, e.g., stirred tanks, stirred tank cascades, autoclaves, tube reactors, and kneading apparatus. The methods of solution polymerization and emulsion polymerization are preferred. Where the polymers of the invention are prepared by free-radical aqueous emulsion polymerization it is advisable to add surfactants or protective colloids to the reaction medium. A compilation of suitable emulsifiers and protective colloids can be found, for example, in Houben Weyl, Methoden der organischen Chemie, Volume XIV/1 Macromolecular compounds, Georg Thieme Verlag, Stuttgart 1961, p. 411 ff.

The polymers are preferably in the form of an aqueous dispersion or solution having solids contents of preferably from 30 to 75% by weight, in particular from 40 to 65% by weight.

In addition to the seed-free mode of preparation it is also possible, for the purpose of setting a defined particle size, to conduct the emulsion polymerization in accordance with the seed latex process or in the presence of seed latex prepared in situ. Processes for doing this are known to the skilled worker and can be found in the state of the art.

The polymers of the invention are outstandingly suitable as additives for adhesives, especially assembly adhesives.

They are distinguished by improved initial adhesion for the fixing of particles characterized by low-absorbency surfaces, such as an acid-resisting brick, for example.

The thickeners are generally substances of high molecular mass which either absorb water and swell in doing so or else form intermolecular lattice structures. Ultimately the organic thickeners undergo transition to a viscous true or colloidal solution.

The organic thickener comprises an aqueous system of a copolymer based on at least acrylic acid and acrylamide, preferably emulsified in an oil fraction, in particular in a petroleum fraction. The solids content of the system is from 20 to 40%, in particular from 24 to 28%, in accordance with DIN 53189 or ISO 1625. Particular preference is given to using Collacral® C (BASF AG). Collacral® C develops its thickening activity primarily in the alkaline range, at a pH of from 7 to 10.

As alternatives it is also possible to use other thickeners based on acrylic acid and acrylamide (e.g., Collacral® HP), carboxyl-containing acrylates, copolymers such as Latekoll® D, PU thickeners (e.g., Collacral® PU 75, Collacral® LR 8989, Collacral® LR 8990, Collacral® PU 85, polyacrylamide), celluloses and their derivatives, and natural thickeners, such as bentonites, alginates or starch, for example.

In order to prepare low-emission products, which are frequently required in interior applications, it is also possible to use pulverulent thickeners based, for example, on acrylate (e.g., Collacral® DS 6254).

The thickeners are used in aqueous form in amounts of 1-10% by weight, preferably 1.5-5% by weight, in powder form amounts of 0.1-10% by weight can be used.

Fillers used are customary fillers, examples being precipitated or natural chalk grades such as Omyacarb® from Omya. Their purpose is to reduce contraction and to influence the consistency.

Examples of further suitable inorganic filler particles include those of andalusite, sillimanite, kyanite, mullite, pyrophyllite, omogolite, and allophane. Suitability extends to compounds based on sodium aluminates, silicates, such as aluminum silicates, calcium silicates or silicas (e.g. Aerosil®), for example, as thixotropic agents. Likewise suitable are minerals such as siliceous earth, calcium sulfate (gypsum), which does not come from flue gas desulfurization plants, in the form of anhydrite, hemihydrate or dihydrate, ground quartz, silica gel, precipitated or natural barium sulfate, titanium dioxide, zeolites, leucite, potash feldspar, biotite, the group of the soro-, cyclo-, ino-, phyllo-, and tectosilicates, the group of the low-solubility sulfates, such as gypsum, anhydrite or heavy spar, and also calcium minerals, such as calcite.

These inorganic materials can be used either individually or as a mixture. Further suitable materials include precipitated or natural kaolin, talc, magnesium hydroxide or aluminum hydroxide (for the purpose of setting the fire classification), zinc oxide, and zirconium salts. By adding lightweight fillers—hollow ceramic microbeads, hollow glass beads, foam glass beads or other lightweight fillers, as prepared by the company Omega-Minerals, for example, it is possible to influence parameters such as dimensional stability and density.

The filler particles have an ×50 for the average particle-size distribution of from about 1 to 120 μm, for example, from about 3 to 60 μm or about 60 to 90 μm, measured using the Sympatec Helos H 0720 in isopropanol.

Likewise suitable for use are organic filler particles not simply classifiable as water-soluble or water-dispersible polymers. They include, in particular, finely ground plastics, such as may be obtained during the recycling of plastics and ground plastics such as are obtainable from the fine grinding of highly crosslinked elastomeric or thermosetting polymers. One example is ground rubber, as produced, for example, by the fine grinding of automobile tires. Further filler particles are polymer fibers, impact modifiers, cellulose fibers, and glass fibers (e.g., wollastonite types).

The purpose of the pigments is to color the (assembly) adhesive. Organic pigments and iron oxides are preferred. Examples are the Luconyl grades from BASF. The pigments are used in amounts of from 0 to 5% by weight, preferably from 0.5 to 2% by weight.

As plasticizers use is made, for example, in an amount of from 0 to 40% by weight, of propylene glycol alkylphenyl ethers, ethylene glycol phenyl ethers, polyisobutylenes, phthalates and/or sulfonates, benzenesulfonamide, resin melts (with natural and synthetic resins) with Pluriols or plasticizers, phosphate esters, di-2-ethylhexyl sebacates (DOS) and di-2-ethylhexyl azelates (DOZ), diisodecyl sebacates (DIDS), tris-2-ethylhexyl trimellitates (trioctyl trimellitate—TOTM), L79TM (an ester of mixed semilinear C₇- and C₉-alcohols) and L810TM, an ester of mixed C8 and C10 linear alcohols, or epoxidized soya bean oil (ESBO) and epoxidized linseed oil (ELO). With preference, however, no plasticizers are used.

Fatty alcohols or derivatives thereof can also be used, especially triglycerides of higher fatty acids and, preferably, natural fats and oils.

Use may be made of phthalates (Palatinol grades), adipates (Plastomoll grades), dicarboxylates (e.g., Hexamoll DINCH), citrates or soft resins (e.g., acResin® DS 3500, Acronal® 4 F).

Examples of the further auxiliaries include preservatives for preventing fungal and bacterial infestation, solvents for influencing the open time and the mechanical properties, such as butyl glycol, dispersing aids for improving wetting, e.g., Pigmentverteiler NL (BASF AG), emulsifiers (Emulphor® OPS 25, Lutensol® TO 89), and frost preventatives (ethylene glycol, propylene glycol). As tackifiers it is possible to use rosin-based or hydrocarbon-based resins. Further possible auxiliaries include crosslinkers, adhesion promoters (acrylic acid, silanes, aziridines) or defoamers (Lumiten grades). The remaining component to 100% by weight is water.

The pH of the adhesive is generally more than 7, preferably in the range from 7 to 10. Within this pH range the thickening effect with the thickeners employed is at its most advantageous. At pH values greater than 10 the acrylate thickeners used are observed to break down, the thickening effect subsides sharply, and at pH values less than 7 there is likewise a marked decrease in the thickening action of the thickeners used.

The high initial adhesion of the assembly adhesive derives essentially from its particular rheology in the state of rest. In the state of rest the assembly adhesive is virtually dimensionally stable. Under mechanical working, in contrast, the viscosity decreases, so that the adhesive can be effectively stirred and processed. Under the action of shearing there is a decrease in the viscosity. As a result the adhesive can be expressed very effectively, for example, from a cartridge. As soon as the shearing forces no longer act on the adhesive, the adhesive regains its original viscosity. There is virtually no observable retarded development of viscosity.

The assembly adhesive of the invention is generally prepared as follows. The dispersion is introduced initially. The pH of the dispersion should be in a range from 7.5 to 8.5 and must be adjusted where appropriate using sodium hydroxide solution or ammonia.

The dispersant and the emulsifier are first added to the dispersion. Thereafter the mixture is mixed for about 10 minutes in a planetary mixer, horizontal turbulent mixer (Drais), planetary dissolver or other dissolver (PC Laborsysteme). After the thixotropic agent has been added the system is homogenized thoroughly and then an aqueous thickener system, e.g. based on acrylic acid and acrylamide is added, and stirring is continued for 10 minutes more. When the batch is homogeneous it is subjected to a vacuum of approximately 10 mbar for about 5 to 10 minutes.

The adhesive can be used easily by anyone without special equipment. The assembly adhesive of the invention can be packaged in cartridges, film bags, buckets, tubes or pressure containers meeting pressurized-gas regulations (such as the German TRG 300).

The adhesive applied is easy to spread out, owing to its creamy consistency.

It can be used for adhesive bonding, coating, sealing, and filling, particularly for the bonding of poorly absorbent substrates, e.g. made from wood, ceramic, glass, cement, metal, and plastics. Its layer thickness can be up to 30 mm, in particular from 1 to 20 mm.

The examples which follow are intended to illustrate the invention but without restricting it to them.

### EXAMPLES

Preparation of the Assembly Adhesive

The dispersion is introduced to start with. The pH of the dispersion ought to be in a region around 7.5-8.5. If necessary the pH must be adapted using sodium hydroxide solution and/or ammonia. The dispersant and the emulsifier are added. The mixture is mixed for about 10 minutes in a planetary mixer/planetary dissolver/dissolver. Subsequently the filler and the thixotropic agent are added and the mixture is thoroughly homogenized. Then the thickener is added and is likewise stirred in well. The last ingredient is the water (which can also be added before the thickener). When the batch is homogeneous, it is evacuated for about 5-10 minutes. Finally the assembly adhesive is dispensed into cartridges/film pouches/pails.

The assembly adhesives were prepared as described above from the following components:

### Example 1

631 parts of aqueous dispersion of a butyl acrylate/methyl methacrylate copolymer (Acronal® A 509 (BASF AG))
13 parts of Pigmentverteiler NL (BASF)
6.5 parts of Lutensol® TO 89 (BASF)
290.5 parts of Omyacarb® 5 GU (Omya)
19.5 parts of Aerosil® 300 (Degussa)
20 parts of Collacral® C (BASF)
19.5 parts of water.

### Example 2

631 parts of aqueous dispersion of a copolymer of acrylic and methacrylic esters (Acronal® DS 6254 (BASF AG))
13 parts of Pigmentverteiler NL (BASF)
6.5 parts of Lutensol® TO 89 (BASF)
290.5 parts of Omyacarb® 5 GU (Omya)
19.5 parts of Aerosil® 300 (Degussa)
20 parts of Collacral® C (BASF)
19.5 parts of water.

### Example 3

63.1 parts of Acronal® A 509
1.3 parts of Pigmentverteiler NL
0.65 parts of Lutensol® TO 89
3.5 parts of water
29.05 parts of Omyacarb® 5 GU
0.8 part of Collacral® DS 6256
1.57 parts of Aerosil® 300

### Example 4

63.1 parts of Acronal® A 509
1.3 parts of Pigmentverteiler NL
0.65 part of Lutensol® TO 89
1 part of Collacral® PU 85
30.05 parts of Omyacarb® 5 GU
5 parts of Aerosil® 300

### Example 5

63.1 parts of Acronal® A 509
1.3 parts of Pigmentverteiler NL
0.65 part of Lutensol® TO 89
1 part of Collacral® PU 85
29.05 parts of Omyacarb® 5 GU
4.5 parts of Aerosil® 300
4.14 parts of water
   Test Methods
   Determination of Extrudability
   Apparatus:

Pneumatic spray gun with perforated closure plate, hole diameter 4 mm, stopwatch, compressed-air supply with valve, manometer for maintaining a constant pressure of 0.8 bar during the test procedure, and with an appropriate attachment piece for the spray gun.

Procedure:

The sealant under test is introduced without bubbles into the spray gun. Subsequently the filled spray gun, with the slide closed, is pressurized to 0.8 bar and held under this pressure constantly throughout the test. Prior to the beginning of the measurement, 2 cm of the sealant are extruded. At least 3 determinations are carried out.

Evaluation:

The sprayout quantity is reported in g/minute.

Substrates:

Beech wood, dimensions 60×40×5 mm

Bond Area:

Beech wood/beech wood 20×40 mm

Adhesive Application:

Using toothed applicator Pajarito F/A1

Load:

24 hours with 500 g

Test Specimen Storage:

14 days under standard conditions 23° C./50% relative humidity
   Method:

The adhesive is applied to the substrate using the toothed applicator. The coated substrate is bonded to an uncoated substrate so as to give a bond width of 20 mm and so that at both ends there is an overhang of 40 mm to be clamped into the testing machine. Subsequently the test area is loaded with a 500 g weight for 24 hours. Testing takes place after 14 days of storage at 23° C./50% relative atmospheric humidity, with a testing speed of 100 mm/min.

Evaluation:

Mean of 3 test specimens in N/mm²

Fracture type assessment

Determination of Shear Strengths

The adhesive is applied to the substrate using a toothed applicator. The coated substrate is bonded to the uncoated substrate so as to produce a bond width of 20 mm, with an excess length of 40 mm remaining free at both ends to allow it to be clamped into the jaws of the testing machine. This bond is loaded immediately with a 500 g weight for 24 hours. After 2 weeks at 23° C./50% relative humidity, shearing takes place in a tensile testing machine at a test speed of 100 mm/min.

At least 3 test specimens are tested. The result is calculated from the mean of the 3 individual tests and is reported in N/mm².

Initial Adhesion with a Nonabsorbent Brick:

Material:

Fulgoplan panel (320×420×20 mm)

Clinker brick, acid-resisting (240×115×65 mm), completely sintered through, water absorbency 3% (tested in accordance with DIN 51056, section 5.2 boiling test), with sharp edges and planar surfaces, right-angled on all sides, without cracks or bubbles, of uniform thickness without warping, manufacturer: Steuler or Keramchemie, color: light, toothed applicator: Pajarito type E (6 mm)

The adhesive is applied to the brick and drawn off slowly toward the slip direction using the toothed applicator. The brick is then pressed onto the Fulgoplan panel, which is still horizontal. The panel is fixed standing upright. A mark is made at the top edge, on both the left and the right. Visual assessment is made after 1 day of storage at 23° C./50% relative atmospheric humidity.

Determination of the Open Time

The adhesive is applied to a fiber cement panel or beech wood panel. After flash-off times of 5, 10, 15, 20, 25 and 30 minutes, the second panel is bonded with a load of 5 s 500 g. Subsequently the test specimen (without additional weight) is suspended on the Nord test testing instrument. An assessment is made of the adhesion of the two panels, in minutes.

TABLE 1

| Test | | | | | | | | |
|---|---|---|---|---|---|---|---|---|
| standard | Storage | | Ex. 1 | Ex. 2 | Ex. 3 | Ex. 4 | Ex. 5 | Powerfix |
| Initial | | Bond 2 × 10 × 0.2 cm | 35 g/cm² | 22.5 g/cm² | 29.5 g/cm² | 38.5 g/cm² | 29.5 g/cm² | 19.5 g/cm² |
| adhesion by | | spring balance (1 kg) | | | | | | |
| Henkel | bonding, 5 min. | | 25 g/cm² | 20 g/cm² | — | — | — | 20 g/cm² |
| method | drying, 2 cm | | | | | | | |
| | shifting, | | | | | | | |
| | measurement | | | | | | | |
| | bonding, 15 Min. | | 20 g/cm² | — | — | — | — | 20 g/cm² |
| | drying, 2 cm | | | | | | | |
| | shifting, | | | | | | | |
| | measurement | | | | | | | |
| | bonding, 30 Min. | | 20 g/cm² | — | — | — | — | 10 g/cm² |
| | drying, 2 cm | | | | | | | |
| | shifting, | | | | | | | |
| | measurement | | | | | | | |
| | beech wood/ | | 18 g/cm² | — | — | — | — | 11 g/cm² |
| | PE panel | | | | | | | |
| Shear | after 2 weeks | PVC/PVC | | | — | — | — | 0.90 N/mm² |
| values | 23° C./50% | | | | | | | adhesion |
| | relative humidity | | | | | | | |
| Shear | after 2 weeks | PVC/PVC | | | | | | |
| values | 23° C./50% | | | | | | | |
| | relative humidity, | | | | | | | |
| | 1 h water | | | | | | | |
| Extrudability | | Nozzle Ø 4 mm, | 996.08 g/min | 2202.84 g/min | | | | 543.36 g/min |
| ISO 9048 | | pressure 0.8 bar | | | | | | |

TABLE 2
Test of open time

| | | | | | | |
|---|---|---|---|---|---|---|
| Example | 5 min. | 10 min. | 15 min. | 20 min. | 25 min. | 30 min. |

Test specimen: fiber cement/fiber cement
Bond area: 60 × 50 mm
Application: 2 mm toothed spreader
Load: 5 s with 500 g

| | | | | | | |
|---|---|---|---|---|---|---|
| Example 1 | >60 | >60 | >60 | Adhesive dried up | — | — |
| Powerfix | >60 | >60 | Adhesive dried up | Adhesive dried up | — | — |

Test specimen: beech wood/beech wood
Bond area: 60 × 50 mm
Application: 2 mm toothed spreader
Load: 5 s with 500 g

| | | | | | | |
|---|---|---|---|---|---|---|
| Example 1 | >60 | >60 | >60 | >60 | Adhesive dried up | — |
| Powerfix | >60 | >60 | >60 | Adhesive dried up | — | — |

Test specimen: fiber cement/fiber cement
Bond area: 60 × 50 mm
Application: 3 mm toothed spreader
Load: 5 s with 500 g

| | | | | | | |
|---|---|---|---|---|---|---|
| Example 1 | >60 | >60 | >60 | >60 | Adhesive dried up | — |
| Powerfix | >60 | >60 | >60 | Adhesive dried up | — | — |

Figures correspond to adhesion in minutes.

1. An adhesive comprising
(A) 10-98% by weight of an aqueous polymer dispersion comprising at least one copolymer selected from the group consisting of ethylenically unsaturated monocarboxylic and dicarboxylic acids, their anhydrides, their ester derivatives, and mixtures thereof,
(B) 1-10% by weight of at least one thickener,
(C) 0-90% by weight of fillers,
(D) 0-5% by weight of pigments,
(E) 0-10% by weight of auxiliaries,
(F) 0-40% by weight of plasticizers,
(G) water, and
(H) tackifiers.

2. An adhesive as claimed in claim 1, wherein 10-98% by weight of an acrylate dispersion is used as component (A).

3. An adhesive as claimed in claim 1 or 2, comprising as component (A) 10-98% by weight of an aqueous butyl acrylate/methyl methacrylate dispersion.

4. An adhesive as claimed in any one of claims 1 to 3, comprising as thickener (B) an aqueous solution of an acrylic acid/acrylamide copolymer.

5. An adhesive as claimed in any one of claims 1 to 4, wherein the pH is greater than 7.

6. The use of an adhesive as claimed in any one of claims 1 to 5 as an assembly adhesive.

7. The use of an adhesive as claimed in any one of claims 1 to 5 as an assembly adhesive on low-absorbency substrates.

8. An assembly adhesive comprising
(A) 10-98% by weight of an aqueous polymer dispersion comprising at least one copolymer selected from the group consisting of ethylenically unsaturated monocarboxylic and dicarboxylic acids, their anhydrides, their ester derivatives, and mixtures thereof,
(B) 1-10% by weight of at least one thickener,
(C) 0-90% by weight of fillers,
(D) 0-5% by weight of pigments,
(E) 0-10% by weight of auxiliaries,
(F) 040% by weight of plasticizers,
(G) water, and
(H) tackifiers.

9. An assembly adhesive as claimed in either of claims 6 and 7, wherein the pH is greater than 7.
